(19) United States
(12) Patent Application Publication
(10) Pub. No.: US 2026/0316846 A1
(43) Pub. Date: Oct. 15, 2026

(54) REAR STRUCTURE OF VEHICLE BODY

(71) Applicants: HYUNDAI MOTOR COMPANY, SEOUL (KR); KIA CORPORATION, SEOUL (KR)

(72) Inventors: Jinyoung Mo, Hwaseong-si (KR); Hyeongwoon Lee, Hwaseong-si (KR); Dong Wook Kim, Hwaseong-si (KR); Jun Young Ahn, Hwaseong-si (KR)

(73) Assignees: HYUNDAI MOTOR COMPANY, SEOUL (KR); KIA CORPORATION, SEOUL (KR)

(21) Appl. No.: 19/574,225

(22) Filed: Mar. 20, 2026

(30) Foreign Application Priority Data
Apr. 9, 2025 (KR) 10-2025-0045988
Sep. 23, 2025 (KR) 10-2025-0136917

(51) Int. Cl. B62D 25/20; B60D 1/48; B60R 19/24

(52) U.S. Cl. CPC B62D 25/2027; B60D 1/488; B60R 19/24; B62D 25/2036

(57) ABSTRACT

A rear structure of a vehicle body is provided. The rear structure includes a rear side member assembly disposed on both sides of a vehicle body in a length direction of the vehicle body, a rear cross member assembly including end parts on both sides bent upwardly and disposed at a rear of the vehicle body in a width direction of the vehicle body to be connected with the each rear side member assembly through the each end part, and a back panel assembly connected to the rear cross member assembly and the rear side member assembly. The rear side member assembly, the rear cross member assembly, and the back panel assembly are connected in a height direction of the vehicle body, the length direction of the vehicle body, and the width direction of the vehicle body at a rear of the rear side member assembly.

### CROSS-REFERENCE TO RELATED APPLICATIONS

This application claims priority to and the benefit of Korean Patent Application No. 10-2025-0045988 filed with the Korean Intellectual Property Office on Apr. 9, 2025, and Korean Patent Application No. 10-2025-0136917 filed with the Korean Intellectual Property Office on Sep. 23, 2025, the entire contents of which are incorporated herein by reference.

### TECHNICAL FIELD

The example embodiment relates to a rear structure of a vehicle body, and more particularly, the present disclosure relates to a rear structure of a vehicle body with increased strength by reinforcing a connection structure.

### BACKGROUND

Development and use of environment-friendly vehicles is expanding as a way to combat environmental pollution

Environment-friendly vehicles include, for example, hybrid vehicles, electric battery vehicles, hydrogen electric vehicles, and the like. As a high voltage battery is mounted on the vehicle, the vehicle body weight tends to be greater than a general internal combustion engine vehicle.

To improve (e.g., secure) the strength of the vehicle body having an increased weight, a bulkhead bracket for reinforcing a rear cross member and a back panel cross-section may be applied to the rear of the vehicle body. However, even if the bulkhead bracket is applied to the rear of the vehicle body, the strength of the vehicle body may not be secured because each component is not three-dimensionally connected.

In addition, in order to secure a wide vehicle interior space by reflecting consumers' demands, an EV low-floor platform may be implemented, and a rear structure with reinforced strength of the low-floor platform may be useful.

The matters described in this background section are for understanding of the background of the example embodiment and may include matters that are not already known to a person of an ordinary skill in the field to which this technology belongs.

### SUMMARY

The present disclosure provides a rear structure of a vehicle body capable of implementing an EV low-floor platform with an improved (e.g., robust) structure.

A rear structure of a vehicle body according to the example embodiment may include a rear side member assembly disposed on both sides of a vehicle body in a length direction of the vehicle body, a rear cross member assembly including end parts on both sides bent upwardly and disposed at a rear of the vehicle body in a width direction of the vehicle body to be connected with the each rear side member assembly through the each end part, and a back panel assembly connected to the rear cross member assembly and the rear side member assembly. The rear side member assembly, the rear cross member assembly, and the back panel assembly are connected in a height direction of the vehicle body, the length direction of the vehicle body, and the width direction of the vehicle body at a rear (e.g., a rear part) of the rear side member assembly.

The rear side member assembly may include a side extension disposed in the length direction of the vehicle body, and a rear side main reinforcing member connected to the side extension, and connected to the rear cross member assembly and the back panel assembly in the length direction of the vehicle body, the width direction of the vehicle body, and the height direction of the vehicle body.

The side extension and the rear side main reinforcing member may have a U-shaped cross-section.

The rear side main reinforcing member may include a main reinforcing member upper flange formed in an upper direction of the vehicle body, and a main reinforcing member rear flange formed in a rear direction of the vehicle body.

The rear side member assembly may further include a rear side lower reinforcing member coupled to a lower part of the rear side main reinforcing member and connected to the rear cross member assembly and the back panel assembly in the length direction of the vehicle body.

The rear cross member assembly and the rear side main reinforcing member may form a main reinforcing cross-section part, and the rear side main reinforcing member and the rear side lower reinforcing member may form a lower reinforcing cross-section part connected to the main reinforcing cross-section part.

The rear cross member assembly may include a rear transverse extension reinforcing portion bent upwardly, and a rear transverse side connected to the rear transverse extension reinforcing portion and disposed in the width direction of the vehicle body.

The rear cross member assembly may further include a rear bumper mounting plate connected to the rear transverse extension reinforcing portion, the rear transverse side, and the rear side main reinforcing member.

The rear transverse side may include a transverse side body connected to the rear side main reinforcing member and bent, and a transverse side lower flange connected to the rear bumper mounting plate.

The cross member assembly may further include an end part bulkhead disposed inside a bent portion of the end part.

The back panel assembly may include a back panel, a side rear bed member connected to the back panel, and a rear transverse extension connected to the back panel, the side rear bed member, and the rear side main reinforcing member.

The back panel assembly may further include a transverse bulkhead connecting the back panel, the side rear bed member, the rear side main reinforcing member, and the rear transverse extension.

The transverse bulkhead may include a transverse inner bulkhead disposed in an inner direction of the vehicle body, and a transverse outer bulkhead disposed in an outer direction of the vehicle body from the transverse inner bulkhead.

The transverse inner bulkhead and the transverse outer bulkhead may form a transverse bulkhead cross-section part connected to a main reinforcing cross-section part formed by the rear side main reinforcing member.

The rear side member assembly may further include a rear side lower reinforcing member coupled to a lower part of the rear side main reinforcing member, wherein a rear coupling component may be coupled to the rear side lower reinforcing member.

The rear side member assembly may further include a rear side member reinforcing lower bracket coupled to the rear side lower reinforcing member.

The rear coupling component may include at least one of a rear bumper back beam and a towing device.

According to an example embodiment, a low-floor platform of a rear structure of a vehicle body may expand a vehicle interior space of a vehicle .

According to the rear structure of a vehicle body according to the example embodiment, strength of a connection portion between an underbody and an upper body can be improved (e.g., secured), and through this, strength against torsion of the vehicle body can be increased.

According to the rear structure of a vehicle body according to the example embodiment, the strength of the connection portion of the vehicle body is secured, so that NVH performance can be improved.

According to the rear structure of a vehicle body according to the example embodiment, at the time of a rear collision of a vehicle, collision energy can be absorbed, and dispersion in a forward direction of the vehicle body is possible.

According to the rear structure of a vehicle body according to the example embodiment, mounting strength of a rear bumper can be secured, and a structure capable of withstanding a securing load during vehicle transport can be provided.

Other effects and/or improvements obtained or predicted by the example embodiment will be directly or indirectly (e.g., implicitly) disclosed in the detailed description of the example embodiment. That is, various effects of example embodiments may be disclosed within the detailed description herein.

### BRIEF DESCRIPTION OF THE DRAWINGS

These drawings are for reference in describing example embodiments, and therefore, the technical idea of an example embodiment should not be interpreted as being limited to the accompanying drawings.

FIG. 1 is a perspective view of a vehicle body to which a rear structure of a vehicle body according to the example embodiment may be applied.

FIG. 2 is a perspective view of a rear structure of a vehicle body according to the example embodiment.

FIG. 3 is an exploded perspective view of a rear side member assembly of a rear structure of a vehicle body according to the example embodiment.

FIG. 4 is a perspective view of a rear side member assembly of a rear structure of a vehicle body according to the example embodiment.

FIG. 5 is an exploded perspective view of a rear cross member assembly of a rear structure of a vehicle body according to the example embodiment.

FIG. 6 is a perspective view of a rear cross member assembly of a rear structure of a vehicle body according to the example embodiment.

FIG. 7 is an exploded perspective view of a back panel assembly of a rear structure of a vehicle body according to the example embodiment.

FIG. 8 is a perspective view of a back panel assembly of a rear structure of a vehicle body according to the example embodiment.

FIG. 9 is a partial perspective view of a rear structure of a vehicle body according to the example embodiment.

FIG. 10 is a cross-section perspective view taken along line Ⅹ-Ⅹ of FIG. 2.

FIG. 11 is a cross-sectional view taken along line ⅩⅠ-ⅩⅠ of FIG. 2.

FIG. 12 is a drawing showing an operation at the time of collision of a rear structure of a vehicle body according to the example embodiment.

FIG. 13 is a drawing of the assembly of a rear back beam of a rear structure of a vehicle body according to the example embodiment.

FIG. 14 is a perspective view showing a rear back beam coupled to a rear structure of a vehicle body according to the example embodiment.

FIG. 15 is a cross-sectional view taken along line ⅩⅤ-ⅩⅤ of FIG. 14.

FIG. 16 is a perspective view showing a towing device coupled to a rear structure of a vehicle body according to the example embodiment.

The drawings referred to above are not necessarily shown to scale, and it should be understood that they present a (e.g., somewhat) simplified representation of various preferred features illustrating (e.g., the basic principles of) an example embodiment disclosed in the present disclosure. For example, various design features of the example embodiment including dimensions, direction, position, and shape may be determined in part by the intended application and use environment.

### DETAILED DESCRIPTION

Hereinafter, an example embodiment will be described in detail with reference to the accompanying drawings. However, an example embodiment may be implemented in many different forms and is not limited to the example embodiment described herein.

In order to explain the example embodiment, parts unrelated to the description may be omitted, and like reference numerals designate like elements throughout the specification.

Since the size and thickness of each component shown in the drawings are arbitrarily shown, the example embodiment is not necessarily limited to those shown in the drawings, and as, for example, the thickness is exaggerated to illustrate (e.g., express) various parts and regions.

The terms used herein are for the purpose of describing example embodiments and are not intended to limit the present disclosure. As used herein, the singular forms are intended to include the plural forms as well, unless the context (e.g., clearly) indicates otherwise.

In addition, in the following detailed description, the names of components are divided into first, second, and the like to distinguish them because they are in the same relationship, and the order is not necessarily limited in the following description.

Throughout the specification, when a part is said to include a certain component, it may indicate that it may further include other components rather than excluding other components unless specifically stated otherwise.

In addition, terms such as “... part,” “... means,” etc. described in the specification indicate a unit of a comprehensive configuration that performs at least one function or operation.

When a part such as a layer, film, region, plate, etc. is referred to as “on” another part, it includes not only the case where it is directly on the other part but also the case where there is another part in the middle.

In contrast, when an element is referred to as being “directly on” another element, there are no intervening elements present.

The terms “comprises” and/or “comprising” as used in this specification indicate the presence of stated features, integers, steps, operations, elements and/or components, but do not exclude the presence or addition of one or more other features, integers, steps, operations, components, and/or groups thereof.

As used in this specification, the term “and/or” includes any one or all combinations of one or more of the associated listed items.

In this specification, the terms “coupled” or “connected” denote a physical relationship between two components where the components are directly connected (e.g., to each other) by, for example, welding, rivet, SPR (Self Piercing Rivet), FDS (Flow Drill Screw), structural adhesive, etc., or indirectly connected through one or more mediating components.

As used in this specification, “vehicle,” “car,” “vehicle’s,” or other similar terms include vehicles, such as passenger vehicles including sports utility vehicles (SUV), buses, trucks, various commercial vehicles, boats including various kinds of boats or ships, aircraft, and similar things, and include hybrid vehicles, electric vehicles, plug-in hybrid electric vehicles, hydrogen fuel vehicles and other alternative fuel (e.g., fuel obtained from resources other than petroleum) vehicles.

In this specification, a reference direction for describing the following components may be set as a vehicle body longitudinal direction (e.g., vehicle body length direction or longitudinal direction), a vehicle width direction (e.g., left-right direction or transverse direction), and a vertical direction (e.g., height direction) with the vehicle body as a reference.

Hereinafter, an example embodiment disclosed in the present disclosure will be described in detail based on the accompanying drawings as follows.

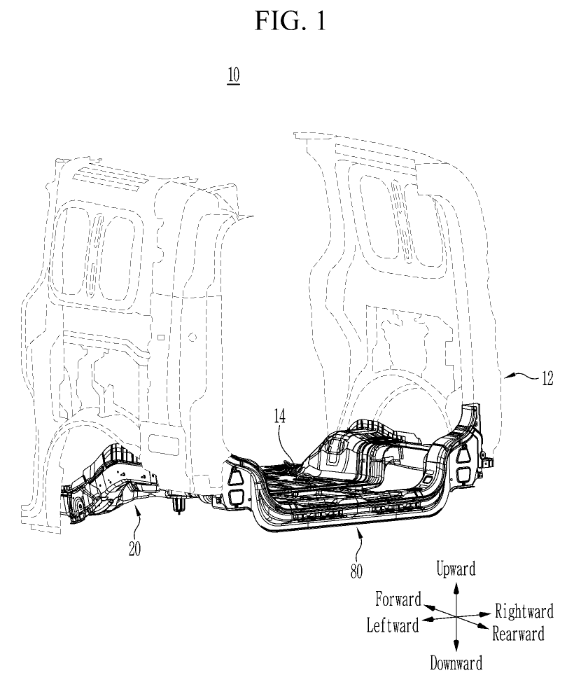

FIG. 1 is a perspective view of a vehicle body to which a rear structure of a vehicle body according to the example embodiment may be applied.

The rear structure of a vehicle body according to the example embodiment may be applied to secure connection strength of a vehicle body 10 in which, for example, a rear pillar 12 is mounted on an upper part of a back panel assembly 80. In addition, the rear structure of a vehicle body according to the example embodiment may implement a low-floor platform by reinforcing a connection structure at the rear of the vehicle body, and through this, a vehicle interior space of a vehicle may be expanded.

The rear pillar 12 may be, for example, a D-pillar, but is not limited thereto.

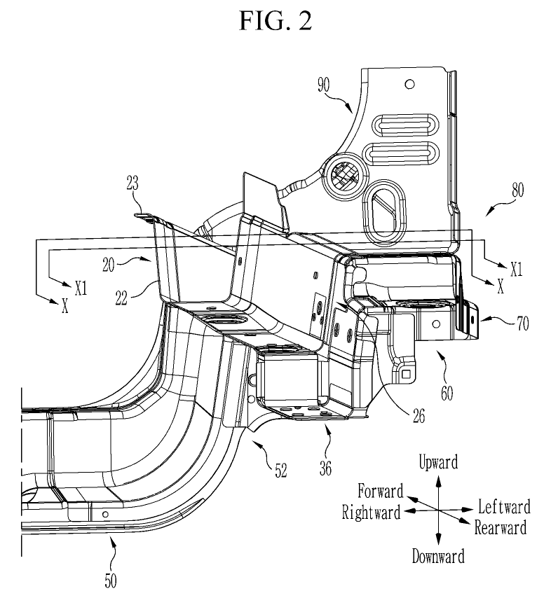

FIG. 2 is a perspective view of a rear structure of a vehicle body according to the example embodiment.

Referring to FIGS. 1 and 2, the rear structure of a vehicle body according to the example embodiment may include a rear side member assembly 20 respectively disposed on both sides of the vehicle body 10 in a length direction of the vehicle body, a rear cross member assembly 50 including end parts 52 on both sides bent upwardly and disposed at a rear of the vehicle body 10 in a width direction of the vehicle body to be connected with the each rear side member assembly 20 through the each end part 52, and the back panel assembly 80 connected to the rear cross member assembly 50 and the rear side member assembly 20.

The rear side member assembly 20, the rear cross member assembly 50, and the back panel assembly 80 may be connected in a height direction of the vehicle body, a length direction of the vehicle body, and a width direction of the vehicle body at a rear (e.g., a rear part) of the rear side member assembly 20.

For example, the rear side member assembly 20, the rear cross member assembly 50, and the back panel assembly 80 are connected to each other in three directions, such as, the height direction of the vehicle body, the length direction of the vehicle body, and the width direction of the vehicle body, so that the connection strength at the rear of the vehicle body may be increased.

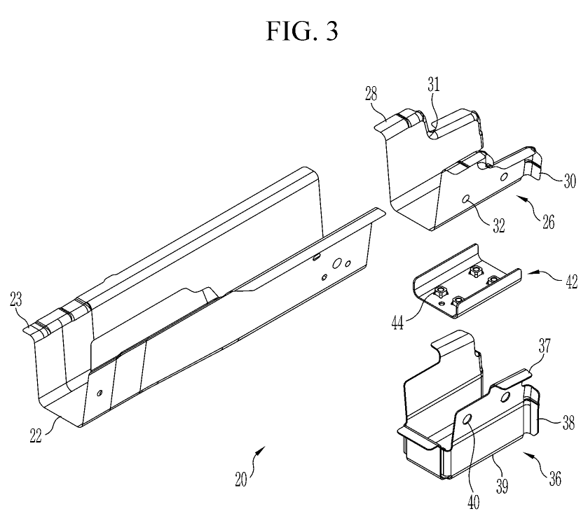

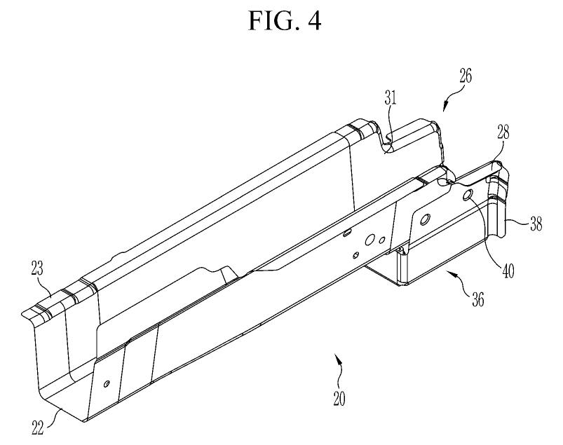

FIG. 3 is an exploded perspective view of a rear side member assembly of a rear structure of a vehicle body according to the example embodiment. FIG. 4 is a perspective view of a rear side member assembly of a rear structure of a vehicle body according to the example embodiment.

Referring to FIGS. 1 to 4, the rear side member assembly 20 may include a side extension 22 disposed in the length direction of the vehicle body, and a rear side main reinforcing member 26 connected to the rear cross member assembly 50 and the back panel assembly 80 in the longitudinal direction of the vehicle body, the width direction of the vehicle body, and the height direction of the vehicle body, respectively.

The side extension 22 and the rear side main reinforcing member 26 may have a U-shaped cross-section. As the side extension 22 and the rear side main reinforcing member 26 are formed in a U shape, a cross-section coefficient may be increased, and strength in the length direction of the vehicle body may be increased.

The side extension 22 and the rear side main reinforcing member 26 may form a main reinforcing cross-section part A, described herein, to increase the strength of a component connection part.

The side extension 22 has an extension upper flange 23 bent and formed on an upper part thereof, and the extension upper flange 23 may be connected to a rear floor 14.

The rear side main reinforcing member 26 may include a main reinforcing member upper flange 28 formed in an upper direction of the vehicle body, and a main reinforcing member rear flange 30 formed in a rear direction of the vehicle body.

The main reinforcing member upper flange 28 is connected to the rear cross member assembly 50 and the back panel assembly 80 in a vertical direction of the vehicle body, and the main reinforcing member rear flange 30 may be connected to the rear cross member assembly 50 and the back panel assembly 80 in the length direction of the vehicle body.

The rear side member assembly 20 may further include a rear side lower reinforcing member 36 coupled to a lower part of the rear side main reinforcing member 26 and connected to the rear cross member assembly 50 and the back panel assembly 80 in the length direction of the vehicle body.

The rear side main reinforcing member 26 and the rear side lower reinforcing member 36 may form a lower reinforcing cross-section part B, described herein, to increase the strength of the component connection part.

A main reinforcing member stepped portion 31 is formed on the rear side main reinforcing member 26 to be coupled to the rear cross member assembly 50, described herein.

A main reinforcing member coupling hole 32 may be formed in the rear side main reinforcing member 26, described herein.

The rear side lower reinforcing member 36 may include a lower reinforcing member upper flange 37 extended upwardly and bent. For example, the lower reinforcing member upper flange 37 may be connected to the main reinforcing member upper flange 28 to increase connection strength with the rear cross member assembly 50.

The rear side lower reinforcing member 36 may further include a lower reinforcing member rear flange 38 bent and formed in a rear direction. For example, the lower reinforcing member rear flange 38 may increase the connection strength in the length direction of the vehicle body together with the main reinforcing member rear flange 30.

The rear side lower reinforcing member 36 may include a lower reinforcing member body 39, and the lower reinforcing member body 39 may protrude downwardly from the vehicle body to increase the strength of the component connection part.

A lower reinforcing member coupling hole 40 may be formed in the rear side lower reinforcing member 36. Other components, such as a rear bumper back beam or a towing device, described herein, may be mounted through the main reinforcing member coupling hole 32 of the rear side main reinforcing member 26 and the lower reinforcing member coupling hole 40.

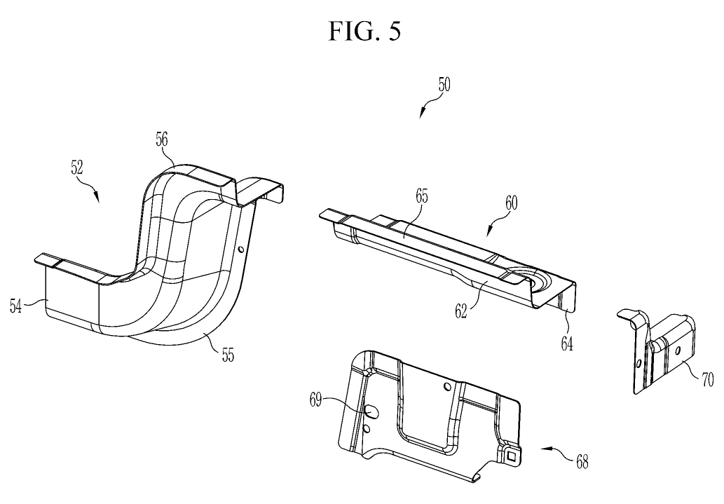

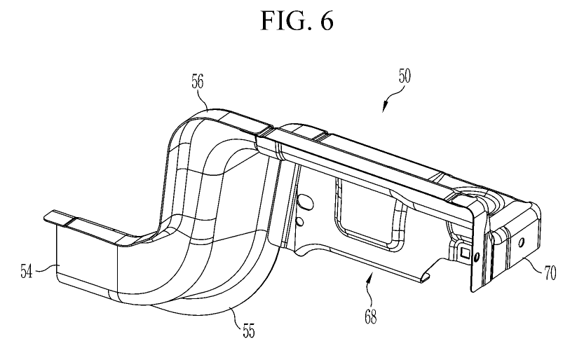

FIG. 5 is an exploded perspective view of a rear cross member assembly of a rear structure of a vehicle body according to the example embodiment. FIG. 6 is a perspective view of a rear cross member assembly of a rear structure of a vehicle body according to the example embodiment.

Referring to FIGS. 1 to 6, the rear cross member assembly 50 may include a rear transverse extension reinforcing portion 54 bent upwardly, and a rear transverse side 60 connected to the rear transverse extension reinforcing portion 54 and disposed in the width direction of the vehicle body.

The rear transverse extension reinforcing portion 54 may form the end part 52 bent upwardly. The rear transverse side 60 may be coupled to an upper part of the rear side member assembly 20.

The rear transverse extension reinforcing portion 54 may include a transverse extension lower flange 55 bent downwardly and a transverse extension upper flange 56 bent at an upper part.

The coupling and shape of the end part 52 bent upwardly and the rear transverse side 60 may expand the vehicle interior space at the rear of the vehicle body. Since a mounting position of the rear floor 14 may be (e.g., relatively) lowered, a low-floor platform of the vehicle body may be implemented.

The rear cross member assembly 50 may further include a rear bumper mounting plate 68 connected to the rear transverse extension reinforcing portion 54, the rear transverse side 60, and the rear side main reinforcing member 26.

The rear bumper mounting plate 68 strengthens connectivity between the rear transverse extension reinforcing portion 54 and the rear transverse side 60, and is connected to the rear side main reinforcing member 26 in the length direction of the vehicle body, so that the connection strength in the length direction of the vehicle body may be increased.

For example, a rear bumper coupling hole 69 is formed in the rear bumper mounting plate 68 so that a rear bumper may be coupled, and an impact load transmitted from the rear at the time of a vehicle collision may be dispersed through the rear bumper mounting plate 68, the rear side main reinforcing member 26, and the rear cross member assembly 50.

The rear transverse side 60 may include a transverse side body 62 connected to the rear side main reinforcing member 26 and may be bent, and a transverse side lower flange 64 connected to the rear bumper mounting plate 68. The rear transverse side 60 may further include a transverse side upper flange 65 bent in a forward direction from the transverse side body 62.

The bent shape of the transverse side body 62 may increase strength in the width direction of the vehicle body by increasing the cross-section coefficient, and the transverse side lower flange 64 is connected to the rear bumper mounting plate 68 in the length direction of the vehicle body to strengthen connectivity.

The bent transverse side body 62 is connected to the main reinforcing member stepped portion 31 of the rear side member assembly 20 to increase coupling strength.

The rear cross member assembly 50 may further include a rear cross member extension side 70 connected to the rear transverse side 60.

A vehicle body rear side panel or the rear pillar 12 may be coupled to the rear cross member extension side 70.

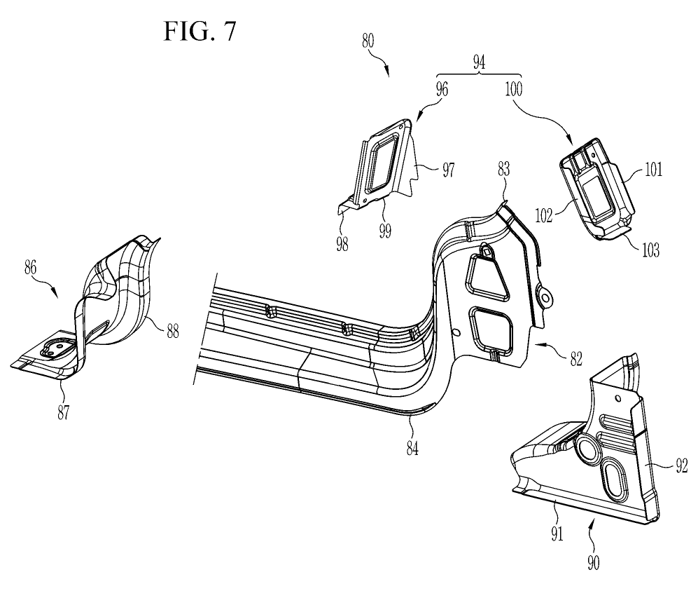

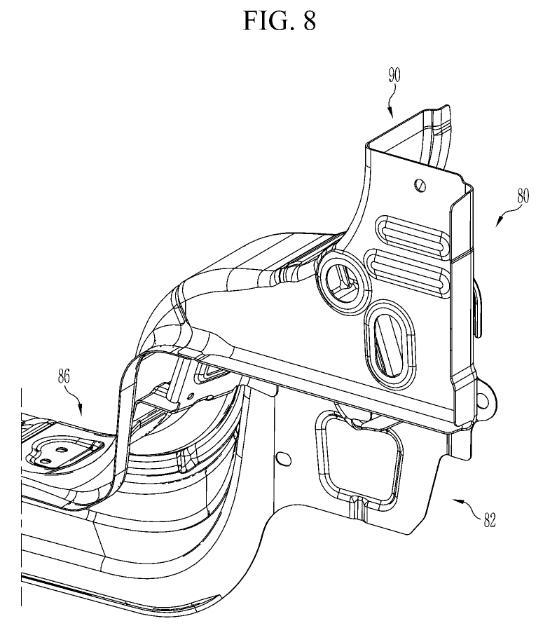

FIG. 7 is an exploded perspective view of a back panel assembly of a rear structure of a vehicle body according to the example embodiment. FIG. 8 is a perspective view of a back panel assembly of a rear structure of a vehicle body according to the example embodiment.

Referring to FIGS. 1 to 8, the back panel assembly 80 may include a back panel 82, a side rear bed member 86 connected to the back panel 82, and a rear transverse extension 90 connected to the back panel 82, the side rear bed member 86, and the rear side main reinforcing member 26.

The back panel 82 may include a back panel rear flange 83 bent at a rear part and a back panel front flange 84 bent forwardly. For example, the back panel front flange 84 is connected to the transverse extension upper flange 56 of the rear transverse extension reinforcing portion 54, and the back panel rear flange 83 is connected to the transverse extension lower flange 55 of the rear transverse extension reinforcing portion 54, so that the rear cross member assembly 50 and the back panel assembly 80 may be connected.

The side rear bed member 86 may include a bed member front flange 87 formed in a forward direction and a bed member rear flange 88 formed in a rear direction. For example, the bed member front flange 87 is connected to the transverse extension upper flange 56 of the rear transverse extension reinforcing portion 54, and the bed member rear flange 88 may be connected to the transverse extension lower flange 55 of the rear transverse extension reinforcing portion 54.

The rear transverse extension 90 may include a transverse extension lower flange 91 formed at a lower part and a transverse extension side flange 92 formed at a side part.

The transverse extension lower flange 91 may be connected to the transverse side upper flange 65 of the rear transverse side 60, and a vehicle body rear side panel or the rear pillar 12 may be connected to the transverse extension side flange 92.

The back panel assembly 80 may further include a transverse bulkhead 94 connecting the back panel 82, the side rear bed member 86, the rear side main reinforcing member 26, and the rear transverse extension 90.

The transverse bulkhead 94 may include a transverse inner bulkhead 96 disposed in an inner direction of the vehicle body, and a transverse outer bulkhead 100 disposed in an outer direction of the vehicle body from the transverse inner bulkhead 96.

The transverse bulkhead 94 may increase the strength of connection portions of the back panel 82, the rear cross member assembly 50, and the rear side member assembly 20.

As shown in the drawings, the transverse bulkhead 94 includes two bulkheads. For example, the two bulkheads may be the transverse inner bulkhead 96 and the transverse outer bulkhead 100, but is not limited thereto. In other example embodiments, one or three or more bulkheads may be applied.

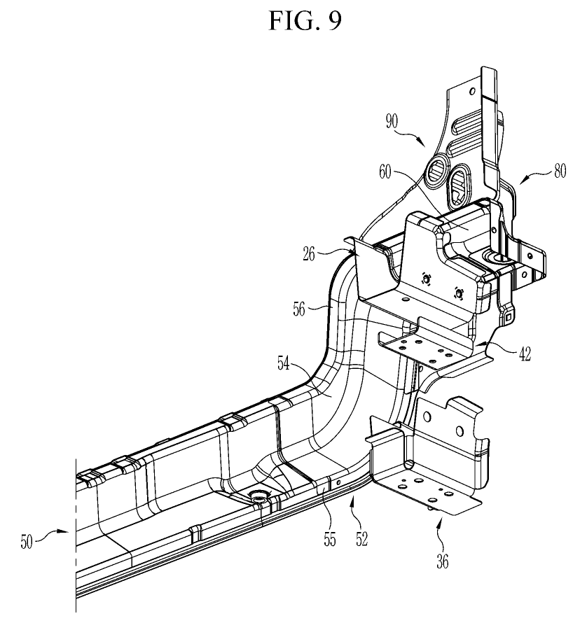

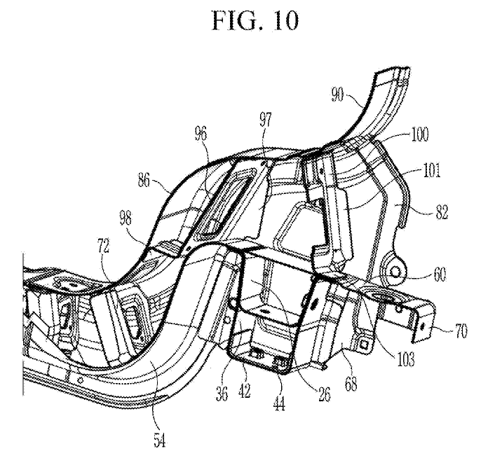

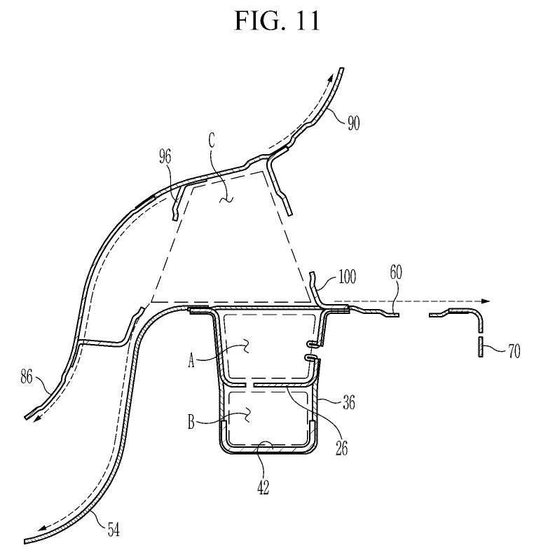

FIG. 9 is a partial exploded perspective view of a rear structure of a vehicle body according to the example embodiment. FIG. 10 is a cross-section perspective view taken along line Ⅹ-Ⅹ of FIG. 2. FIG. 11 is a cross-sectional view taken along line ⅩⅠ-ⅩⅠ of FIG. 2.

Referring to FIGS. 1 to 11, the rear cross member assembly 50 and the rear side main reinforcing member 26 form the aforementioned main reinforcing cross-section part A, and the rear side main reinforcing member 26 and the rear side lower reinforcing member 36 may form the lower reinforcing cross-section part B connected to the main reinforcing cross-section part A.

As shown in FIG. 11, since the main reinforcing cross-section part A and the lower reinforcing cross-section part B are formed as adjacent dual cross-sections, the strength at the rear of the vehicle body may be increased, and a load may be dispersed.

The transverse inner bulkhead 96 may include a transverse inner bulkhead rear flange 97 connected to the back panel 82, a transverse inner bulkhead lower flange 98 connected to the side rear bed member 86, and a transverse inner bulkhead body 99 connected to an upper part of the rear cross member assembly 50.

The transverse outer bulkhead 100 may include a transverse outer bulkhead rear flange 101 connected to the back panel 82, a transverse outer bulkhead front flange 102 connected to the rear transverse extension 90, and a transverse outer bulkhead lower flange 103 connected to an upper part of the rear cross member assembly 50.

The transverse inner bulkhead 96 and the transverse outer bulkhead 100 may form a transverse bulkhead cross-section part C connected to the main reinforcing cross-section part A formed by the rear side main reinforcing member 26.

Since the main reinforcing cross-section part A and the transverse bulkhead cross-section part C are formed as adjacent dual cross-sections, the strength at the rear of the vehicle body may be increased, and a load may be dispersed. The transverse bulkhead cross-section part C is illustrated in the drawings as being formed in a rectangular shape, but is not limited thereto, and may be provided in various shapes that disperse loads by being adjacent to the main reinforcing cross-section part A.

A plurality of cross-section parts A, B, and C are formed at parts where the rear side member assembly 20, the rear cross member assembly 50, and the back panel assembly 80 are coupled, so that coupling strength between each component may be increased, and NVH performance may be improved by smoothly transmitting loads between components.

As shown in FIG. 10, the rear cross member assembly 50 may further include an end part bulkhead 72 disposed inside the bent portion of the end part 52.

The end part bulkhead 72 may reinforce the strength of the rear cross member assembly 50, and may increase the strength of the bent end part 52 to secure an expanded vehicle interior space.

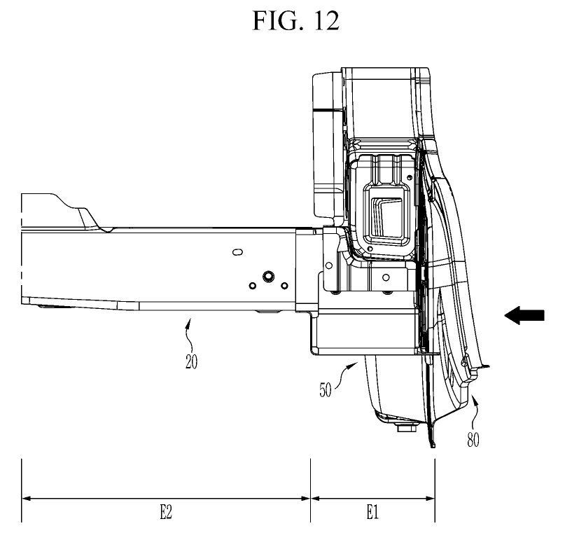

FIG. 12 is a drawing showing an operation at the time of collision of a rear structure of a vehicle body according to the example embodiment.

Referring to FIG. 12, the rear structure of a vehicle body according to the example embodiment may function as a primary collision energy absorption part E1 at the time of a rear collision of the vehicle body, and the rear side member assembly 20 may function as a secondary collision energy absorption part E2.

The rear side member assembly 20, the rear cross member assembly 50, and the back panel assembly 80 are connected in the height direction of the vehicle body, the length direction of the vehicle body, and the width direction of the vehicle body, so that at the time of a rear impact of the vehicle body, an impact load may be dispersed to the rear side member assembly 20, the rear cross member assembly 50, and the back panel assembly 80, thereby improving the safety of occupants.

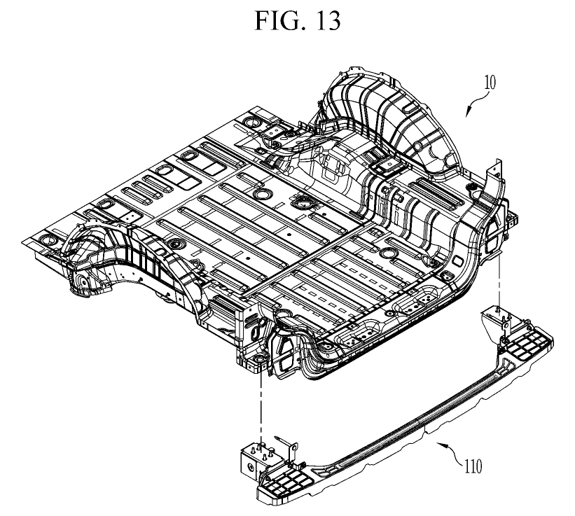

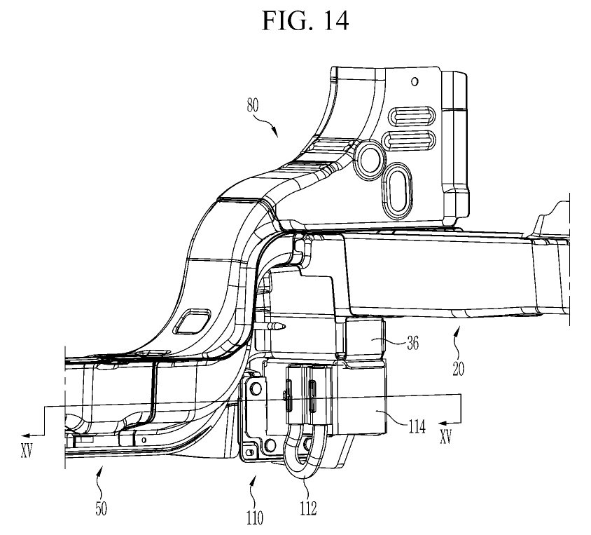

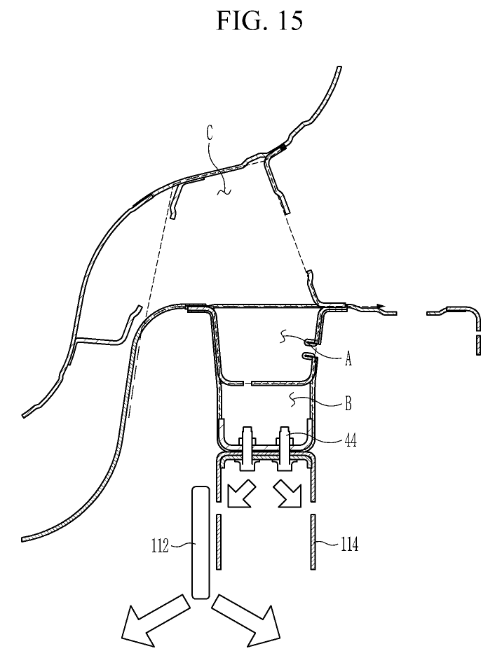

FIG. 13 is a drawing explaining assembly of a rear back beam of a rear structure of a vehicle body according to the example embodiment. FIG. 14 is a perspective view showing a rear back beam coupled to a rear structure of a vehicle body according to the example embodiment. FIG. 15 is a cross-sectional view taken along line ⅩⅤ-ⅩⅤ of FIG. 14.

Referring to FIGS. 13 to 15, a rear coupling component may be coupled to the rear side lower reinforcing member 36.

For example, the rear coupling component may include a rear bumper back beam 110, and the rear bumper back beam 110 may be coupled in the height direction of the vehicle body.

A low-floor platform may be implemented by the shape and coupling structure of the end part 52 bent upwardly and the rear side member assembly 20, and space utilization may be increased as the rear bumper back beam 110 is coupled in an upward direction.

Referring to at least FIGS. 3, 9, 11, and 15, the rear side member assembly 20 may further include a rear side member reinforcing lower bracket 42 coupled to the rear side lower reinforcing member 36.

The rear side member reinforcing lower bracket 42 is coupled to the rear side lower reinforcing member 36 and may disperse a load to the vehicle body through the rear side lower reinforcing member 36.

For example, as shown in FIG. 15, a securing hook mounting bracket 114, on which a securing hook 112 is mounted, may be coupled to the rear side member reinforcing lower bracket 42. The securing hook mounting bracket 114 may be coupled to the rear side lower reinforcing member 36 and the rear side member reinforcing lower bracket 42 through a lower bracket coupling bolt 44. During vehicle transport, a load transmitted from the securing hook 112 is dispersed to the vehicle body through the rear side lower reinforcing member 36 and the rear side member reinforcing lower bracket 42, so that the vehicle body may be (e.g., stably) supported.

According to the rear structure of a vehicle body according to the example embodiment, a (e.g., robust) mounting structure may be secured even if the distance between the rear side member assembly 20 and the rear back beam 110 is (e.g., relatively) increased.

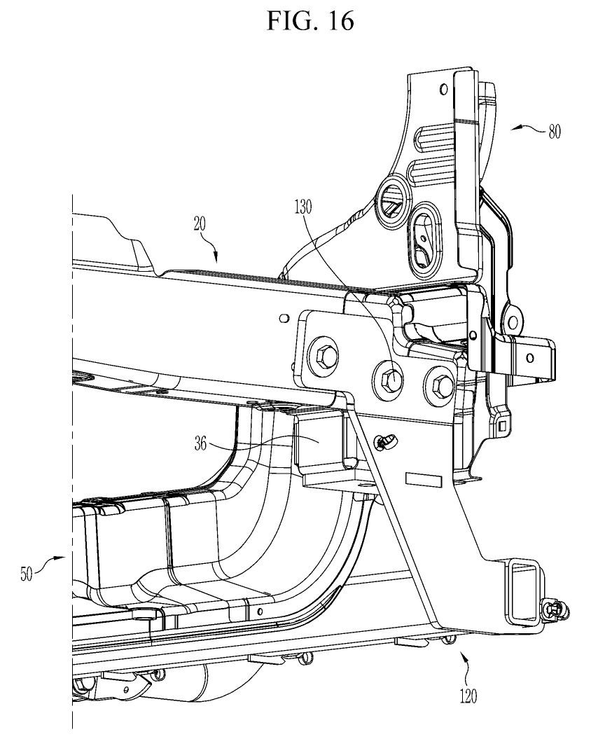

FIG. 16 is a perspective view showing a towing device coupled to a rear structure of a vehicle body according to the example embodiment.

The rear coupling component may include a towing device 120 as shown in FIG. 16.

As the towing device 120 is coupled to the rear side main reinforcing member 26 and the rear side lower reinforcing member 36 of the rear side member assembly 20, a towing load may be (e.g., stably) dispersed to the vehicle body.

For example, referring to at least FIGS. 3, 4, and 16, the towing device 120 may be coupled to the main reinforcing member coupling hole 32 of the rear side main reinforcing member 26 and the lower reinforcing member coupling hole 40 of the rear side lower reinforcing member 36 using fasteners 130 such as bolts.

The main reinforcing cross-section part A and the lower reinforcing cross-section part B are formed as (e.g., adjacent) dual cross-sections to increase the strength at the rear of the vehicle body, and even if the towing device 120 is coupled, the towing load may be dispersed by the dual cross-section shape.

As described herein, according to an example embodiment of the rear structure of a vehicle body, a low-floor platform may be provided to expand a vehicle interior space of a vehicle.

According to the rear structure of a vehicle body, according to the example embodiment, strength of a connection portion between an underbody and an upper body may be provided (e.g., secured), and through this, strength against torsion of the vehicle body may be increased.

According to the rear structure of a vehicle body according to the example embodiment, the strength of the connection portion of the vehicle body is provided (e.g., secured), so that NVH performance may be improved.

According to the rear structure of a vehicle body according to the example embodiment, at the time of a rear collision of a vehicle, collision energy may be absorbed and dispersion in a forward direction of the vehicle body is possible.

According to the rear structure of a vehicle body according to the example embodiment, mounting strength of a rear bumper may be provided (e.g., secured), and a structure capable of withstanding a securing load during vehicle transport may be provided.

According to the rear structure of a vehicle body according to the example embodiment, even when applied to an EV vehicle whose vehicle body weight is relatively increased, a (e.g., robust) connectivity of vehicle body rear parts may be provided (e.g., secured), so that a low-floor platform may be implemented.

According to the rear structure of a vehicle body according to the example embodiment, since the strength of a joint portion of the configuration is increased, a (e.g., relatively) low rear floor may be applied.

The example embodiment has been described above, but the example embodiment is not limited to the embodiment and includes (e.g., all) changes within a range recognized as equivalent by being (e.g., easily) changed by a person of an ordinary skill in the technical field to which the example embodiment of the present disclosure belongs.

What is claimed is:

1. A rear structure of a vehicle body comprising:
a rear side member assembly disposed on a first side and a second side of a vehicle body in a length direction of the vehicle body;
a rear cross member assembly including a first end part configured to connect a first side of the rear cross member assembly to the rear side member assembly, and a second end part configured to connect to a second side of the rear cross member assembly to the rear side member assembly, wherein the first end part and the second end part are bent upwardly and disposed at a rear of the vehicle body in a width direction of the vehicle body; and
a back panel assembly connected to the rear cross member assembly and the rear side member assembly,
wherein the rear side member assembly, the rear cross member assembly, and the back panel assembly are connected in a height direction of the vehicle body, the length direction of the vehicle body, and the width direction of the vehicle body at a rear of the rear side member assembly.

2. The rear structure of the vehicle body of claim 1, wherein the rear side member assembly includes:
a side extension disposed in the length direction of the vehicle body; and
a rear side main reinforcing member connected to the side extension, and the rear side main reinforcing member is connected to the rear cross member assembly and the back panel assembly in the length direction of the vehicle body, the width direction of the vehicle body, and the height direction of the vehicle body.

3. The rear structure of claim 2, wherein the side extension and the rear side main reinforcing member have a U-shaped cross-section.

4. The rear structure of claim 2, wherein the rear side main reinforcing member includes:
a main reinforcing member upper flange formed in an upper direction of the vehicle body; and
a main reinforcing member rear flange formed in a rear direction of the vehicle body.

5. The rear structure of claim 2, the rear side member assembly includes:
a rear side lower reinforcing member coupled to a lower part of the rear side main reinforcing member, and the rear side lower reinforcing member is connected to the rear cross member assembly and the back panel assembly in the length direction of the vehicle body.

6. The rear structure of claim 5, wherein:
the rear cross member assembly and the rear side main reinforcing member form a main reinforcing cross-section.

7. The rear structure of claim 6, wherein the rear side main reinforcing member and the rear side lower reinforcing member form a lower reinforcing cross-section.

8. The rear structure of claim 7, wherein the lower reinforcing cross-section is connected to the main reinforcing cross-section.

9. The rear structure of claim 2, wherein the rear cross member assembly includes:
a rear transverse extension reinforcing portion bent upwardly; and
a rear transverse side connected to the rear transverse extension reinforcing portion and disposed in the width direction of the vehicle body.

10. The rear structure of claim 9, wherein the rear cross member assembly includes a rear bumper mounting plate connected to the rear transverse extension reinforcing portion, the rear transverse side, and the rear side main reinforcing member.

11. The rear structure of claim 10, wherein the rear transverse side includes:
a transverse side body connected to the rear side main reinforcing member and is bent; and
a transverse side lower flange connected to the rear bumper mounting plate.

12. The rear structure of claim 9, wherein the rear cross member assembly includes an end part bulkhead disposed within a bent portion of at least one of the first end part or the second end part.

13. The rear structure of claim 2, wherein the back panel assembly includes:
a back panel;
a side rear bed member connected to the back panel; and
a rear transverse extension connected to the back panel, the side rear bed member, and the rear side main reinforcing member.

14. The rear structure of claim 13, wherein the back panel assembly includes a transverse bulkhead connecting the back panel, the side rear bed member, the rear side main reinforcing member, and the rear transverse extension.

15. The rear structure of claim 14, wherein the transverse bulkhead includes:
a transverse inner bulkhead disposed in an inner direction of the vehicle body; and
a transverse outer bulkhead disposed in an outer direction of the vehicle body from the transverse inner bulkhead.

16. The rear structure of claim 15, wherein the transverse inner bulkhead and the transverse outer bulkhead form a transverse bulkhead cross-section connected to a main reinforcing cross-section formed by the rear side main reinforcing member.

17. The rear structure of claim 2, wherein the rear side member assembly includes a rear side lower reinforcing member coupled to a lower part of the rear side main reinforcing member.

18. The rear structure of claim 17, wherein a rear coupling component is coupled to the rear side lower reinforcing member.

19. The rear structure of claim 18, wherein the rear side member assembly includes
a rear side member reinforcing lower bracket coupled to the rear side lower reinforcing member.

20. The rear structure of claim 19, wherein the rear coupling component includes at least one of a rear bumper back beam or a towing device.
